(19) United States
(12) Patent Application Publication
(10) Pub. No.: US 2025/0061127 A1
(43) Pub. Date: Feb. 20, 2025

(54) SYSTEMS AND METHODS FOR INTEGRATING AND OPTIMIZING SECURITY SYSTEMS

(71) Applicant: The PNC Financial Services Group, Inc., Pittsburgh, PA (US)

(72) Inventors: Vorachat Tamarree, Pittsburgh, PA (US); Leonard Michael Bencloski, Herminie, PA (US); Paige Heather Querry, Kittanning, PA (US)

(73) Assignee: The PNC Financial Services Group, Inc., Pittsburgh, PA (US)

(21) Appl. No.: 18/933,214

(22) Filed: Oct. 31, 2024

Related U.S. Application Data
(62) Division of application No. 18/365,430, filed on Aug. 4, 2023.
(60) Provisional application No. 63/459,517, filed on Apr. 14, 2023.

(51) Int. Cl. G06F 16/25; H04L 9/40

(52) U.S. Cl. CPC G06F 16/254; H04L 63/0807

(57) ABSTRACT

A system for processing a plurality of ETL jobs is provided. The system comprises a token-based security system comprising providing a token in response to receiving a token request associated with an application programming interface (API) call. The system further comprises a message header table including one or more message headers, where in a message header contains the token. The system further comprises a plurality of API calls associated with the ETL jobs, wherein each API call includes security information. The system utilizes the token and the security information to determine permissions for the use of the plurality of API calls to run in real-time.

### CROSS REFERENCE TO RELATED APPLICATION

This application claims the benefit of priority to U.S. Provisional Patent Application No. 63/459,517 filed Apr. 14, 2023, the entire contents of which are incorporated by reference.

### TECHNICAL FIELD

The present disclosure relates generally to systems and methods for authenticating data using an extract, transform, and load (ETL) service by integrating mainframe data into a modern distributed application in real time. The present disclosure also relates to methods for optimizing a security system and methods for integration of optimization objectives into an ETL process.

### BACKGROUND INFORMATION

Many organizations have large amounts of data that may be stored in different ways. For example, data may be stored on a mainframe computer in relational structures or it may be stored in on-premises or cloud solutions. Before the advent of more modern data storage solutions, data warehouses housed data in one location. Today, data may be stored in multiple locations in different formats, such as structured or unstructured. However, as may organizations know, decisions cannot be made on older data, even data that is a few days old may impact business decisions. Thus, it is critical to get data from the mainframe computer into an on-premises or cloud solutions quickly. A mainframe computer may be a high-performance computer with large amounts of memory and processors to process calculations and transactions. In some embodiments, mainframe computers are used for bulk data processing. An on-premise solution may comprise software that is installed locally on an organization's computers and servers. By contrast, a cloud solution may be hosted on a cloud vendor server “off-premise” and be accessed using a web browser.

Importing data into a target source from a third party may have its challenges when using extract, transform, and load (ETL) processes due to the volume and size of data, as well as issues with storage and data compatibility. These issues may occur with large ETL workloads and transferring large amounts of data, leading to network latency, which can slow down the process of importing data into a target source. If there are not enough computing resources to handle the ETL workloads, such as lack of memory or storage, this can also slow down the process. In addition, inaccurate or outdated data records can also lead to issues with ETL workloads. It is important to verify information before it is loaded into a target source.

ETL processes combine data from multiple sources into a large, central repository, known as the target source. ETL processes allow an organization to access data from multiple sources and integrate it into a target source. APIs provide a standardized interface for connecting otherwise incompatible systems, making it easier to integrate different data sources. Token-based authentication is often used to validate a user's credentials using a token that contains data that identifies a particular user and has an expiry time. The token may then be used to access restricted resources, such as certain APIs, within a predetermined time period. Thus, to efficiently perform ETL processes using APIs, it is important to have a verifiable authentication method to run the APIs that performs in an efficient manner to streamline the process. Traditional ETL processes read and processed data from various sources and systems and loaded the data into a target source using batch processing. The current solution uses APIs to perform the ETL processes, streamlining the process and creating more efficient workloads.

Thus, a solution is needed to seamlessly integrate data from various sources and systems into a target source efficiently and in a recognizable format. Integrations that are configured to establish a secure connection with an authentication service can help with this process by authenticating APIs rather than using batch processing. Current solutions may not be able to perform this operation in real time. This is because traditional ETL processes use batch processing and, therefore, cannot leverage different data sources in real time. The current solution solves this problem by establishing a secure connection with an authentication service to authenticate and transform the data before it is loaded into a target source using APIs. In addition, the current solution performs this process in real time, eliminating delays and issues with previous solutions.

### SUMMARY

Embodiments in accordance with this disclosure include a system for processing a plurality of extract transform load (ETL) jobs. For example, in various exemplary embodiments a token-based security system includes a token retriever and a message header table in which each message header contains a security token. Such an exemplary system further includes a plurality of application programming interface (API) calls associated with ETL jobs in which each API call includes security information. In such exemplary systems, the security token and the security information are utilized to determine which of the plurality of API calls to run in real time.

According to some embodiments, the token may be provided to an API in a data response message.

According to some embodiments, the data response message may include a REST response message.

According to some embodiments, the system may receive the token as a header value in a data request message.

According to some embodiments, the data request message may include a REST request message.

According to some embodiments, the token-based security system may generate the token based on an Open Authorization (OAuth) protocol.

According to some embodiments, the token may be valid for a predetermined period of time.

According to some embodiments, the token request may include a client identifier.

According to some embodiments, the token request may include a secret value and the secret value may be provided for an application associated with the API call prior to receiving the token request.

According to some embodiments, the system may validate the token request based on the client identifier and the secret value.

Embodiments in accordance with this disclosure include a method for optimizing a security system. For example, in exemplary embodiments, a method may include receiving by a computer processor, a request for a token, receiving, by a computer processor into a data store, an integration instruction from a token-based security system and restructuring an extract transform load (ETL) process, based on the integration instruction. Such an exemplary method further includes optimizing the ETL process based on the restructuring and storing the optimized ETL process as executable code.

According to some embodiments, the restructuring includes performing a token-based authentication process.

According to some embodiments, the token-based authentication process may be performed based on an Open Authorization (OAuth) protocol.

According to some embodiments, the optimizing may include retrieving an access token from the token-based security system.

According to some embodiments, the data response message may include a REST response message.

According to some embodiments, the optimizing may include providing an access token to a resource server as a header value in a data request message.

According to some embodiments, the data request message includes a REST request message.

According to some embodiments, the optimizing may include sending a token request to the token-based security system, the token request including a client identifier and a secret value.

According to some embodiments, the secret value may be received from the token based security system prior to sending the token request.

Embodiments in accordance with this disclosure include a method for integration of optimization objectives into an extract transform load (ETL) process on a computing system. For example, in at least one embodiment, a method may include receiving optimization objectives for an ETL process from a system of record database and entering the optimization objectives into a token-based security system. In such methods, an ETL process is restructured based on the optimization objectives, and the restructured ETL process is sent for display to a financial application on a user device.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 illustrates an example system environment for processing a plurality of ETL jobs, consistent with disclosed embodiments.

FIG. 2 is a block diagram showing an example server, consistent with disclosed embodiments.

FIG. 3 is a flowchart illustrating an example process for optimizing a security system, consistent with disclosed embodiments.

FIG. 4 is a flowchart illustrating an example process for integrating optimization objectives into an ETL process on a computing system, consistent with disclosed embodiments.

FIG. 5 illustrates an example environment for using extract, transform, and load technology using a token-based authentication system to optimize security, consistent with disclosed embodiments.

### DETAILED DESCRIPTION

In the following detailed description, numerous specific details are set forth to provide a thorough understanding of the disclosed example embodiments. However, it will be understood that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence or constrained to a particular system configuration. Additionally, some of the described embodiments or elements thereof can occur or be performed simultaneously, at the same point in time, or concurrently.

Reference will now be made in detail to the disclosed embodiments, examples of which are illustrated in the accompanying drawings.

When importing data into a target source from a source, it is necessary to have authentication methods that streamline the process. In some embodiments, the source is the origin of the data and the target source is the database, data warehouse, or data lake to which the data is being moved. Data may be any information that is translated into a form that is efficient for movement or processing. For example, consider that the data stored in the source was contained within mainframe database tables that were incompatible with a target source, which is a data warehouse stored in a cloud solution. Previously, because the data was stored in two different formats, a mainframe database table and a date warehouse, it would not be possible to move the data from one location to the other because of incompatibility issues with the data formats. These data formats are required for proper storage. Thus, a solution was needed to extract the data from the source (the mainframe table for example), transform the data into a readable format for the target source (the data warehouse for example), and load the data from the source into the target source. To do this in a secure and efficient manner, a solution was needed to perform this process using APIs, rather than the traditional method of batch processing data in groups.

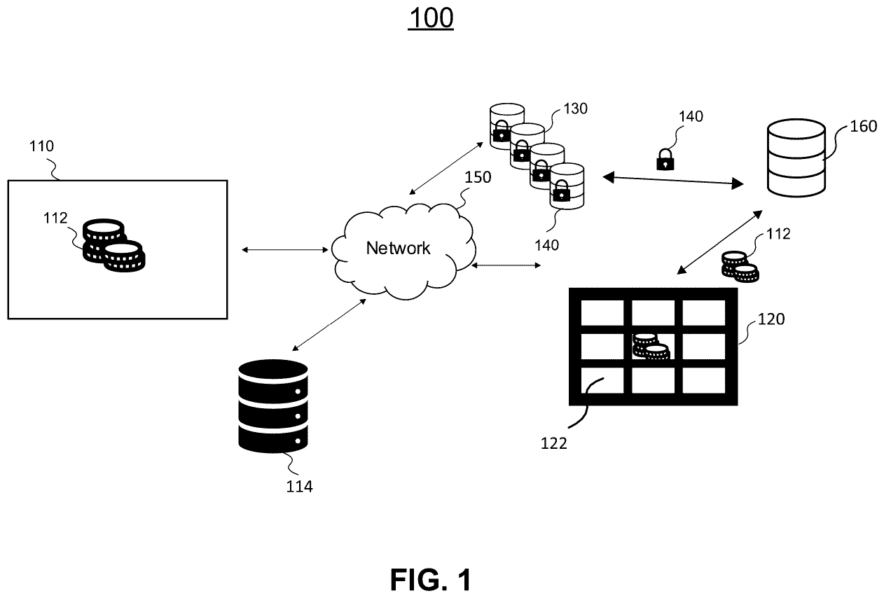

The present solution uses token-based authentication to integrate authentication into an ETL process. By using a token-based method, the ETL process can save the token for use in multiple processes. The token may be stored as a variable in memory of an application and could be used for additional API calls. In other embodiments, the token-based method creates tokens that are unique to the session. Further, the present solution allows for data to be directly sent from the source to the target in real time, rather than in batch files or updates to a separate database. This improves the user experience by providing instant information to a user rather than having to wait for the availability of data. By increasing efficiency and the availability of real-time data, the present solution also simplifies the ETL process between the data source and the target source and processing the data based on the APIs. FIG. 1 illustrates an example system environment 100 for processing a plurality of extract transform load (ETL) jobs. System environment 100 may include a security system 110, security tokens 112, a message header table 120, message headers 122, a plurality of API calls 130, security information 140, network 150, and API calls to run 160. Security system 110 may include a token-based authentication system for authenticating one or more applications or users. Security system 110 may use one or more security tokens 112 for authenticating the one or more applications or users.

A security token may refer to a compilation of alphanumeric characters, numbers, symbols, codes, or algorithms that may be used by security system 110 for authenticating the one or more applications or users. For example, in some exemplary embodiments, the information included in token 112 may be used to determine the scope of services available for an API call or the specific API call that may be invoked bases on that token. In some embodiments, a Hypertext Transfer Protocol (HTTP) is used to communicate the API calls. In some exemplary embodiments, tokens 112 may include computer-generated security codes. In some exemplary embodiments, token 112 may include a physical or digital device that provides two-factor authentication for a user or application to prove their identity. In some exemplary embodiments, In some embodiments, token 112 may include a mathematical algorithm that generates a long sequence of characters that are verified using an API call.

In some embodiments, tokens may be encoded using an algorithm. In some embodiments, tokens are encoded using Base64 using the Json Web Token (JWT) format.

In some embodiments, system 100 comprises a message header table 120. In some embodiments, message header table 120 may include message headers 122. Message headers 122 may refer to an email message or application. For example, message header 122 may comprise a list of technical details about the message, including who sent the message, the software used to compose the message, and the servers the message passed through. In some embodiments, message header 122 may include identifying and routing information for a message. In some embodiments, token 112 may contain the contents of message header 122. In some embodiments, message header 122 may enable the transfer of data between a server and a client based on an API call. In some embodiments, message header table 120 consists of a set of standard fields.

In some embodiments, system environment 100 may include a plurality of application programming interface (API) calls 130. An “API call,” as used herein refers broadly to any request, response, message, or exchange of data between two or more computer systems, such as between client and server, or any combination of backend, middleware, and frontend components. Example API calls include calls related to read functions, write functions, delete functions, get/fetch functions, post functions, update functions, upload functions, download functions, functions to add or remove objects, start instances, stop or terminate instances, authentication functions, custom functions, or any other function. In some embodiments, each API call 130 may contain a message header 122. In some embodiments, the message header 122 may contain information for a specific API call 130. For example, the message header may comprise metadata associated with an API call. In some embodiments, message header 122 may contain extra information for each API call 130.

In some embodiments, a token-based authentication system is used to authenticate users or processors. In some embodiments, a user's application or process will send a request to the authentication server, such as server 114, to confirm a user's identity and issue a token, such as token 112. The user then uses token 112 to access an application using API calls. This process of authentication to access applications minimizes security risks associated with traditional login methods. Token 112 may be used as a unique identifier of an application requesting access to a service to perform the ETL process. The use of tokens in this way replaces the traditional username and password combinations. In some embodiments, OAuth2 is used for authentication.

In some embodiments, each API call of the plurality of API calls 130 is verified using security information 140. Security information 140 may be viewed as a passkey for the API to be verified. If the security information 140 is not present or is incorrect, the API call will not be performed. In some embodiments, the security information 140 may comprise confidential or private information.

In some embodiments, system 100 may utilize the token 112 and security information 140 to determine which API calls 160 to run out of the plurality of API calls 130. In some embodiments, token 112 may contain one or more restrictions to determine which API calls 160 to run. For example, restrictions may correspond to conditions for when an API call can be run, a group of users that are denied access, a geographic location, or restricted access. For example, system 100 may determine to run an API call after it receives and validates an access token from the API using an OAuth authentication process. OAuth is an open standard for authorization that uses access tokens instead of credentials. OAuth operates by enabling an application to obtain limited access to certain data without using a password. As another example, system 100 may determine not to run an API call if it does not receive a valid access token from the API in a predetermined period of time. In some embodiments, the restrictions may be embedded in token 112 as parameter values that may be parsed to determine the associated restrictions. In some embodiments, real-time API operations may take place within one second.

In some embodiments, system 100 may be configured to determine that token 112 has expired and is no longer valid. In some embodiments, system 100 may send a request for another token if token 112 has expired. The same token may be reused up until its expiration time of 1 hour. Once a token expires, an unauthorized error code will be returned in response to an API call. At that point, a new OAuth call for a new access token may be required.

The various components of system 100 may communicate over a network 150. Such communications may take place across various types of networks 150, such as the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth, infrared, etc.), or various other types of network communications. In some embodiments, the communications may take place across two or more of these forms of networks and protocols. While system environment 100 is shown as a network-based environment, it is understood that in some embodiments, one or more aspects of the disclosed systems and methods may also be used in a localized system, with one or more of the components communicating directly with each other.

ETL stands for extract, transform, and load. This term is often used in data warehousing, to bring data from multiple different sources into one centralized database. Before the data can be centralized, it must be extracted from the original source, transformed, and then loaded into the target source. In some embodiments, the data may be extracted from various data systems, where the extracted data may include mainframe files, Windows files, Unix files, operating system files, or database tables. In some embodiments, the data may be extracted from an existing database, from a cloud environment, from an on-premise environment, from a data storage platform, or from a data warehouse. In some embodiments, a cloud environment may refer to servers that are accessed over the Internet and the software and databases that run on those servers. Cloud computing allows users to not have to manage physical servers or run software applications on their own machines. An on-premise solution may comprise software that is installed locally on an organization's or user's computers and servers. A data storage platform may be a set of technologies that allow for the acquisition, storage, preparation, delivery, and governance of data. In some embodiments, a data storage platform may also allow for a security layer for both users and applications. A data warehouse may refer to a central repository of integrated data from one or more sources. The data extraction may be performed based on the underlying data structure stored in the source database. In some embodiments, data transformation comprises cleansing the data to resolve inconsistencies and missing values. In some embodiments, data transformation comprises standardizing the data to a common format based on pre-defined rules. In some embodiments, data transformation comprises deduplication of the data based on excluding redundant or duplicated data. In some embodiments, data transformation comprises verification of the data based on anomalies. In some embodiments, data transformation comprises sorting the data according to type (e.g., numbers, characters, Booleans). In some embodiments, loading the data comprises loading the transformed data into a new destination. In some embodiments, the new destination is a data lake (e.g., a data repository including various sources that store the data in its original format, such as structured data, semi-structured data, or unformatted data) or a data warehouse (e.g., current data and historical data from various systems that has been converted to a particular format for analytics). In some embodiments, the data is loaded in increments or batches. In other embodiments, the data is loaded all at once. In some embodiments, the data may be loaded as a flat file that contains source data including account number information, date information, and balance information associated with a user account.

In some embodiments, the data is loaded as an HTTP input. The loaded information may include information from the flat file as described with respect to FIG. 1.

In some embodiments, security system 110 may comprise a token-based authentication system, such as authentication server 114, to authenticate applications or users. In some embodiments, token-based authentication is a protocol that allows a user or application to verify their identity, and in response, receive a unique access token. Before the token expires, using the token allows a user or application to access information that the token was issued for. In some embodiments, authentication server 114 may manage processes that allow access to security system 110 over a network, such as network 150. In some embodiments, authentication server 114 may generate tokens 112 in response to a request from an application. In some embodiments, security system 110 may use tokens 112 to perform authentication. In some embodiments, tokens 112 may be computer-generated security codes. In some embodiments, tokens 112 may include a physical or digital device that provides two-factor authentication for a user or application to prove their identity. In some embodiments, a protocol may allow a user or application to verify their identity. In some embodiments, the protocol may be a username and password, or a client ID and a client secret to obtain a token from the OAuth service. Each time an access token, such as token 112 is requested, the protocol is presented for the OAuth service provider to validate. In some embodiments, token 112 may have a digital signature embedded in it. The signature may be used to verify that the token 112 is valid. In response to verification of the user's or application's identity, the user or application may receive a token 112. In some embodiments, token 112 may comprise a unique access token that comprises a tiny piece of code with data. The unique access token may be used to allow an application to access an API after a user or application successfully authenticates and authorizes access. The token may contain specific information about what the user or application has access to and what actions may be performed based on what was granted during authorization. For example, the token may contain parameters such as grant_type indicating the type of grant, scope, client_ID, and client_secret. In some embodiments, the grant_type parameter may refer to the way an application gets an access token. Each grant type may be optimized for a particular use case, such as a web application or server-to-server applications. The grant_type parameter may enable a user or application to have limited access to an application.

The scope parameter may refer to which permissions the application or user is requesting. In some embodiments, the specific OAuth API will define the scope that is supported.

The client_ID parameter may be the public identifier for the application. The client_secret parameter may be the application's client secret. This parameter may be used to ensure that the request to get the access token is made only from the application and not from a potential attacker or hacker.

In some embodiments, the grant_type, scope, client_id, and client_secret parameters are embedded in token 112 as an HTTP output.

In some embodiments, token 112 may have a predetermined life, or period of time, during which it is active, and can be used for authentication. In some embodiments, token 112 may be invalidated once a user logs out or quits an application. Token 112 may be a token as described previously. For example, token 112 may include a string of alphanumeric characters and/or special characters. The string may represent information such as the scope of the services the token is used for, for example, the specific APIs the token can be used for. If the token is used for applications outside the permitted scope of services, the access request may be denied by the resource server. The string may also represent information relating to an expiration date of the token.

In some embodiments, tokens may be encoded using an algorithm. In some embodiments, the algorithm may be a Base64 algorithm. In some embodiments, encoding may allow the contents of a token to be compacted and more easily transmitted using API calls. In some embodiments tokens may be decoded using a Base64 decode algorithm. In some embodiments, decoding a token allows one to see the contents of the tokens. In some embodiments, the token may only contain access values. In some embodiments, the token may contain validity information related to an expiration date. In some embodiments, token 112 may be a mathematical algorithm that generates a long sequence of characters that are verified using an API call. When the token is decoded, the token may contain metadata about what API services can be accessed with the specific tokens.

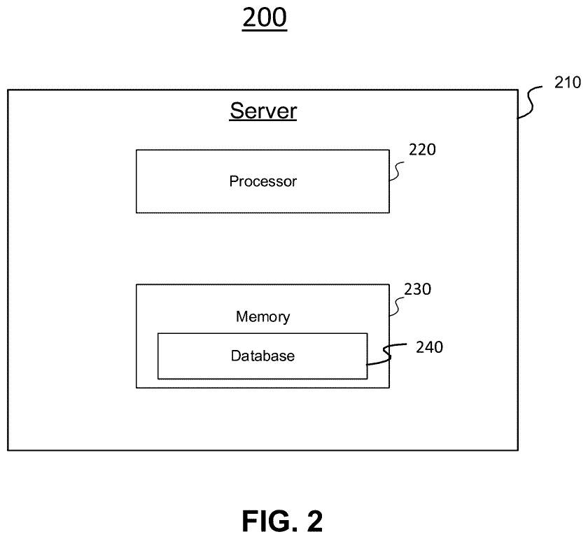

Token 112 may include a digital signature that is validated to indicate that the token is provided by a trusted source. In some embodiments, the REST API will check the digital signature of the token against a private trust store that contains a list of trusted signers to verify the signature of the token. In some embodiments, security system 110 may receive a request to access a server or a protected resource. In some embodiments, the request may comprise a login with a password. In some embodiments, a server, such as server 210 may determine whether the request should be verified. In some embodiments, server 210 may communicate with an authentication server, such as authentication server 114. to verify the request. Server 210 will be further described with reference to FIG. 2.

FIG. 2 is a block diagram showing an example server 210, consistent with the disclosed embodiments. Server 210 may include any form of computing device configured to receive, store, and transmit data. For example, server 210 may be a server configured to store files accessible through a network (e.g., a web server, application server, virtualized server, etc.). Server 210 may be a computing device (e.g., a computer, switch, router, server, etc.) and may include one or more dedicated processors and/or memories. For example, server 210 may include a processor (or multiple processors) 220, a memory (or multiple memories) 230, and a database 240 as shown in FIG. 2.

Processor 220 may take the form of, but is not limited to, a microprocessor, embedded processor, or the like, or may be integrated in a system on a chip (SoC). Furthermore, according to some embodiments, processor 220 may be from the family of processors manufactured by Intel®, AMD®, Qualcomm®, Apple®, NVIDIA®, or the like. The processor 220 may also be based on the ARM architecture, a mobile processor, or a graphics processing unit, etc. The disclosed embodiments are not limited to a particular type of processor configured in server 210. Processor 220 may be implemented as one or more known or custom processing devices designed to perform functions of the disclosed methods, such as single- or multiple-core processors capable of executing parallel processes simultaneously to allow a computing device to execute multiple processes simultaneously. For example, processor 220 may be configured with virtual processing technologies. Processor 220 may implement virtual machine technologies, including a Java virtual machine, or other known technologies to provide the ability to execute, control, run, manipulate, store, etc., multiple software processes, applications, programs, etc.

Memory 230 may include one or more storage devices configured to store instructions used by the processor 220 to perform functions related to server 210. The disclosed embodiments are not limited to particular software programs or devices configured to perform dedicated tasks. For example, the memory 230 may store a single program, such as a user-level application, that performs the functions associated with the disclosed embodiments, or may comprise multiple software programs. Additionally, the processor 220 may, in some embodiments, execute one or more programs (or portions thereof) remotely located from server 210. Furthermore, memory 230 may include one or more storage devices configured to store data for use by the programs. Memory 230 may include, but is not limited to a hard drive, a solid state drive, a CD-ROM drive, a peripheral storage device (e.g., an external hard drive, a USB drive, etc.), a network drive, a cloud storage device, or any other storage device. Memory 230 may include instructions to enable processor 220 to execute programs, such as one or more operating systems, server applications, network communication processes, and any other type of application or software known to be available on computer systems. Alternatively or additionally, instructions may be stored in remote storage (not shown) in communication with one or more database or memory modules accessible over system 100. The one or more memory 320 may embody non-transitory computer readable media, for example, Random Access Memory (RAM) devices, NOR or NAND flash memory devices, and Read Only Memory (ROM) devices, CD-ROMs, hard disks, floppy drives, optical media, or solid state storage media.

In some embodiments, memory 230 may include a database 240 as described above. Database 240 may be included on a volatile or non-volatile, magnetic, semiconductor, tape, optical, removable, non-removable, or other type of storage device or tangible or non-transitory computer-readable medium. Database 240 may also be part of server 210 or separate from server 210. When database 240 is not part of server 210, server 210 may exchange data with database 240 via a communication link. In some embodiments, a communication link may be a dedicated physical link or virtual circuit that connects one or more devices to transmit data. Database 240 may include one or more memory devices that store data and instructions used to perform one or more features of the disclosed embodiments. Database 240 may include any suitable databases, ranging from small databases hosted on a work station to large databases distributed among data centers. Database 240 may also include any combination of one or more databases controlled by memory controller devices (e.g., server(s), etc.) or software. For example, database 240 may include document management systems, Microsoft SQL™ databases, SharePoint™ databases, Oracle™ databases, Sybase™ databases, other relational databases, or non-relational databases, such as mongo and others.

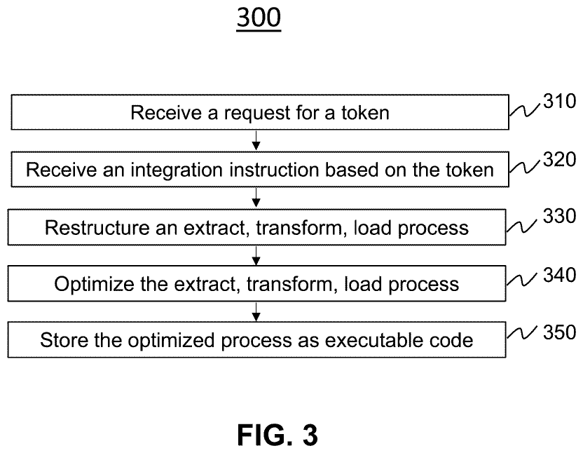

FIG. 3 is a flowchart illustrating an example process for optimizing a security system, consistent with disclosed embodiments. Process 300 may be performed by at least one processing device of a server, such as processor 220, as described above. In some embodiments, a non-transitory computer-readable medium may contain instructions that when executed by a processor cause the processor to perform process 300. Further, process 300 is not necessarily limited to the steps shown in FIG. 3.

In step 310, process 300 may include receiving, by a processor, a request for a token by a user or an application. The token request may identify an API call to be accessed and a user for whom the token is for. The token request may be generated in response to system 100 determining that a token is needed to run a particular API call. In some embodiments, the token request may comprise a request to refresh a token when the token has expired.

In some embodiments, the token may be stored in memory, such as memory 230. In some embodiments, the token may be included in a header of an integration instruction, as described in step 320. Tokens are computer-generated and may be encrypted. A token may be decrypted using a decrypt_client parameter.

In step 320, process 300 may include receiving, by a processor, an integration instruction from a token-based security system. In some embodiments, the integration instruction may include instructions for data transformation for an ETL process by a processor, such as processor 220. The instructions included in the integration instruction for data transformation may include instructions that may define processes to refine data such that the data can be formatted for analysis, integration, authentication or any other process. In some embodiments, the integration instruction may comprise instructions to restructure datasets to refine or parse data to exclude data that does not conform to predetermined rules or configurations. In some embodiments, the integration instruction may comprise one or more rules based on constraints specified in the token. In some embodiments, restructuring may comprise restructuring data for compatibility to change the data type of a data value, configure data point date formats, or configure the precision of a data value. In some embodiments, the token-based security system may be the security system as described in reference to FIG. 1.

In some embodiments, the integration instruction for data transformation may use HTTP transformation rules to modify HTTP requests and responses. The HTTP transformation may also be used to connect a source and target to view and modify data passing through the HTTP transformation.

In some embodiments, the HTTP transformation may include the grant_type, scope, client_id, and client_secret parameters as described with respect to FIG. 1.

In step 330, process 300 may include restructuring, based on the integration instruction, an ETL process. In some embodiments, restructuring may comprise data transformation based on the integration instruction and obtaining authorization from the security system based on the integration instruction. Data transformation may comprise changing the format, structure, or values of data. Data transformation may be constructive, such as adding, copying or replicating data. Data transformation may be destructive, such as deleting data fields. Data transformation may be aesthetic, such as standardizing data types. Data transformation may be structural, such as renaming, moving, or combining columns in a database. In some embodiments, the token-based authentication process includes a process consistent with the Open Authorization (OAuth) standard. OAuth is a standard that applications can use to provide client applications with access to certain data or function. OAuth works over HTTPs and authorizes devices, applications, servers, and users through tokens instead of credentials. After obtaining authorization for accessing the data, the ETL process may access the data and transform the data from its source format or structure (i.e., its originally stored format or structure) into a different format or structure.

In step 340, process 300 may include optimizing, based on the restructuring, the ETL process. In some embodiments, the optimizing may include a faster, more efficient transformation for the ETL process. For example, the optimizing may include retrieving, by an application on a user device, a token from an authentication server, such as an OAuth authentication server. In some embodiments, the user device may comprise a mobile device, tablet, laptop, personal computer or any other device that may be capable of accessing web pages or other network locations. A user device may also include a processor or memory as described with respect to FIG. 2. The application may provide the token to a resource server to obtain authorization to retrieve information from the resource server. In some embodiments, step 340 may include the application sending a token request to the authentication server. The token request may include a client identifier. In some embodiments, the OAuth application and an authorization server, such as authorization server 114 may have access to a secret value that is used in authentication. The secret value may include an alphanumeric string generated by the authentication server. The secret value may be encrypted and stored in a parameter file associated with the ETL process associated with the token request. The token request may also indicate the scope the token is used for, e.g., for a single API service or for multiple API services.

In response to the token request, the authentication server may validate the client identifier and secret value. If the client identifier and secret value are validated, the authentication server may return an access token to the application. The authentication server may send the access token to the application in a data response message, such as a Representational State Transfer (REST) response message. While APIs are a set of rules that define how applications can connect and communicate with one another, REST APIs conform to a representational state transfer design style. REST APIs communicate through HTTP. REST APIs operate using stateless client-server communication, so no client information is stored between requests and each request is separate and unconnected.

After receiving the access token, the application may send the access token to a resource server. In some embodiments, the access token may be included in a data request message, e.g., a REST request message, as a header value. The resource server may receive the access token and may validate the token using a digital signature. If the access token is successfully validated, the resource server may process the request message and may provide data to the application. In some embodiments, the ETL process may perform the authentication process for each API call to the resource server and obtain a new access token for each API call. In some embodiments, the REST API may contain security information, access tokens, or other metadata about the request. In some embodiments, the REST API is standardized using HTTP protocol and format.

By performing the above described token-based authentication process, the ETL process is optimized by adopting a secure authentication process that is less complex and requires less processing time compared with prior authentication schemes used with the ETL process.

In step 350, process 300 may include storing the optimized ETL process as executable code. For example, process 300 may include storing the token-based authentication process as executable code. The executable code, when executed, may cause the application to send a token request to the authentication server and may cause the authentication server to issue an access token to the application. In some embodiments, the executable code may comprise programs written in interpreted languages that may require additional software to execute. In other embodiments, the executable code may comprise a program filed stored in a format that is executable by a computer processing system without modification.

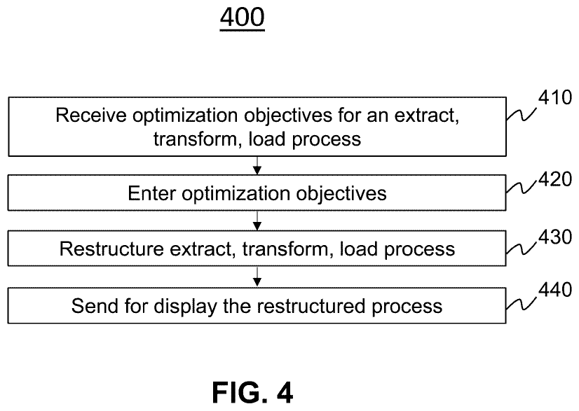

FIG. 4 is a flowchart illustrating an example process for integrating optimization objectives into an ETL process on a computing system, consistent with disclosed embodiments. Process 400 may be performed by at least one processing device of a server, such as processor 220, as described above. In some embodiments, a non-transitory computer-readable medium may contain instructions that when executed by a processor cause the processor to perform process 400. Further, process 400 is not necessarily limited to the steps shown in FIG. 4.

In step 410, process 400 may include receiving optimization objectives for an ETL process from a system of record database. In some embodiments, the database may be database 240 as described in references to FIG. 2. In some embodiments, the optimization objectives may comprise an objective to make the ETL process more efficient. This process is faster, provides better security, and is easier to configure and maintain compared to previous methods. For example, the solution using optimization objectives may comprise performing a token-based authentication process consistent with the OAuth standard. As another example, the optimization objectives may comprise performing an authentication process via a REST based web service.

In step 420, process 400 may comprise entering the optimization objectives into a token-based security system. In some embodiments, the token-based security system may be the security system as described in reference to FIG. 1. For example, the optimization objectives may be based on having data point values that are more precise and may include rounding data points based on precision factors. In other embodiments, the optimization objectives may be based on data type conversion. For example, if there are data types of an integer type, those may be incompatible with a decimal data type. The optimization objectives may be configured to convert data into one data type for easier processing. In other embodiments, data may be formatted so that each data point has a date formatted. In some embodiments, converting a data type allows for easier search and storage. The embodiments listed are exemplary.

In step 430, process 400 may comprise restructuring the ETL process based on the optimization objectives. In some embodiments, the restructuring includes performing an authentication process according to an authentication protocol, e.g., the OAuth protocol, and obtaining an access token from the authentication server. The restructuring may include the application sending a token request to the authentication server, the token request including a client identifier and a secret value provided by the authentication server for the application.

In step 440, process 400 may comprise sending for display to a financial application on a user device, data returned from the restructured ETL process. For example, process 400 may comprise sending for display to a user device the requested data from the resource server, which can include information associated with the client that is authenticated by the resource server. In some embodiments, a financial application may comprise a software program that facilitates the management of the ETL process. It is to be understood that the disclosed embodiments are not necessarily limited in their application to the details of construction and the arrangement of the components and/or methods set forth in the following description and/or illustrated in the drawings and/or the examples. The disclosed embodiments are capable of variations, or of being practiced or carried out in various ways.

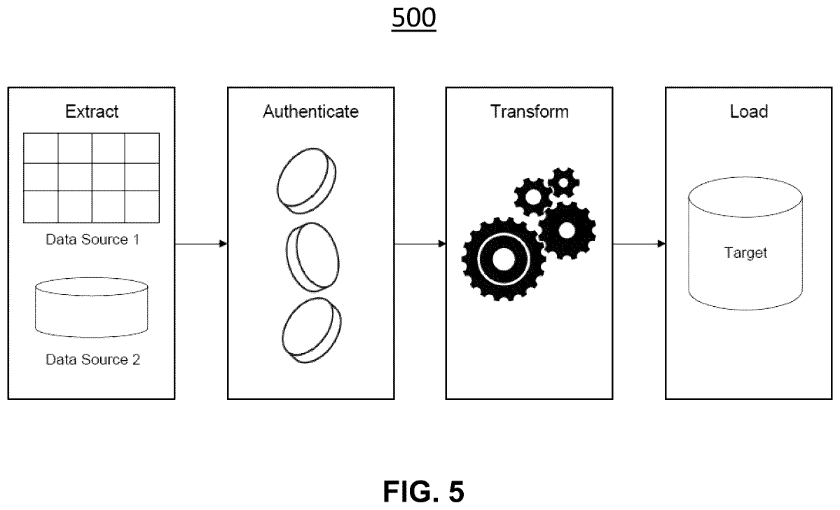

FIG. 5 illustrates an example environment 500 for using extract, transform, and load technology using a token-based authentication system to optimize security, consistent with disclosed embodiments. FIG. 5 shows the process of extracting data from a source. This may include multiple data sources, as shown in exemplary FIG. 5, where the data may be stored in different formats, as in data source 1 and data source 2. FIG. 5 shows the process of authentication configured to authenticate the process using tokens. In some embodiments, authentication occurs through an authorization framework that enables applications to obtain access. FIG. 5 then shows the process of transforming data, which may involve cleaning, deduplicating, naming, and normalizing data, and then the process of loading the data into a target source. The process of loading may involved loading the newly transformed data into a new destination, known as the target source. Data may be loaded all at once or at scheduled interviews.

The disclosed embodiments may be implemented in a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowcharts or block diagrams may represent a software program, segment, or portion of code, which comprises one or more executable instructions for implementing the specified logical function(s). It should also be noted that, in some alternative implementations, the functions noted in the block may occur out of the order noted in the figures. Some steps may be deleted, added, or modified. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1-20. (canceled)

21. A method for integration of optimization objectives into an extract transform load (ETL) process on a computing system, comprising:
receiving optimization objectives for an ETL process from a system of record database;
entering the optimization objectives into a token-based security system;
restructuring the ETL process based on the optimization objectives; and
sending for display to a financial application on a user device, the restructured ETL process.

22. The method of claim 21, wherein the integration is configured to establish a secure connection with the computing system.

23. The method of claim 21, wherein the integration is an integration instruction.

24. The method of claim 23, wherein the integration instruction includes instructions to restructure datasets to refine data associated with the ETL process.

25. The method of claim 21, wherein one of the optimization objectives includes an objective to make the ETL process faster.

26. The method of claim 21, wherein the optimization objective performs a token-based authentication process.

27. The method of claim 21, wherein the optimization objective is based on data type conversion.

28. The method of claim 21, wherein the optimization objective is configured to convert data into one data type.

29. The method of claim 21, wherein the restructuring further includes sending a token request for authentication.

30. The method of claim 21, wherein the financial application is a program to facilitate management of the ETL process.

31. A computing system for integration of optimization objectives into an extract transform load (ETL) process, the system comprising:
a memory storing instructions;
a processor electronically coupled to the memory and configured to execute the instructions to:
receive optimization objectives for an ETL process from a system of record database;
enter the optimization objectives into a token-based security system;
restructure the ETL process based on the optimization objectives; and
send for display to a financial application on a user device, the restructured ETL process.

32. The system of claim 31, wherein the integration is configured to establish a secure connection with the computing system.

33. The system of claim 31, wherein the integration is an integration instruction.

34. The system of claim 33, wherein the integration instruction includes instructions to restructure datasets to refine data associated with the ETL process.

35. The system of claim 31, wherein one of the optimization objectives includes an objective to make the ETL process faster.

36. The system of claim 31, wherein the optimization objective performs a token-based authentication process.

37. The system of claim 31, wherein the optimization objective is based on data type conversion.

38. The system of claim 31, wherein the optimization objective is configured to convert data into one data type.

39. The system of claim 31, wherein the restructuring further includes sending a token request for authentication.

40. The system of claim 31, wherein the financial application is a program to facilitate management of the ETL process.
